(19) United States
(12) Patent Application Publication
(10) Pub. No.: US 2022/0398656 A1
(43) Pub. Date: Dec. 15, 2022

(54) Voice Enabled Flash Briefing of Banking Information

(71) Applicant: Wells Fargo Bank, N.A., San Francisco, CA (US)

(72) Inventor: Ganesan Anand, Fremont, CA (US)

(21) Appl. No.: 16/227,628

(22) Filed: Dec. 20, 2018

(51) Int. Cl. G06Q 40/02; G06N 20/00; G06F 3/16

(52) U.S. Cl. CPC G06Q 40/02; G06N 20/00; G06F 3/167

(57) ABSTRACT

Various examples are directed to computer-implemented systems and methods for providing a voice enabled flash briefing of banking information. A method includes receiving, by a processor of a computer, a voice input from a user of a device, the voice input related to a financial account of the user. The processor processes the voice input and stored information related to the financial account to obtain user-specific financial information regarding the financial account customized for the user. A financial flash briefing is provided using the user-specific financial information, the financial flash briefing configured for output by the device.

### TECHNICAL FIELD

Embodiments described herein generally relate to automated financial account management and, for example and without limitation, to systems and methods for voice enabled flash briefing of banking information.

### BACKGROUND

A financial account holder may encounter situations in which it would be desirable to obtain a summary of banking information without the use of a manual keyboard. The account holder would also benefit from being able to obtain targeted or personalized banking information in audio format using a voice command.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1A illustrates an example embodiment of a system for providing a voice enabled flash briefing of banking information;

FIG. 1B illustrates example embodiments of information that may be provided for a voice enabled flash briefing of banking information;

FIG. 1C illustrates an example embodiment of a user interface for a voice enabled flash briefing of banking information;

FIG. 1D illustrates an example embodiment of a computer-implemented method for providing a voice enabled flash briefing of banking information;

FIG. 2 illustrates an exemplary infrastructure for providing a voice enabled flash briefing of banking information;

FIG. 3 illustrates an example embodiment of a computing device used by a user to obtain a voice enabled flash briefing of banking information;

FIG. 4 illustrates an example embodiment of a computing device used for to obtain a voice enabled flash briefing of banking information; and

FIG. 5 is a block diagram of a machine in the example form of a.

computer system within which a set of instructions may be executed, for causing the machine to perform any one or more of the methodologies discussed herein.

### DETAILED DESCRIPTION

The present subject matter provides a system and method for providing a voice enabled flash briefing of banking information. The flash briefing may be provided to users that have an online banking relationship with a financial institution. In one embodiment, users have at least one demand deposit account (DDA), such as a checking account. The flash briefing may provide customer-specific financial information as part of a daily, weekly or on-demand briefing for the user.

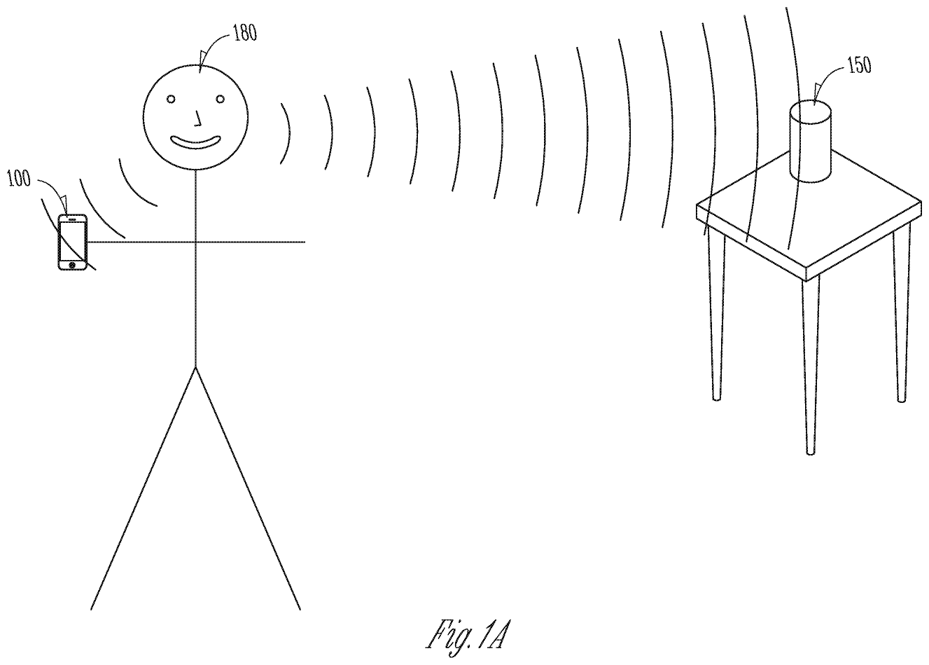

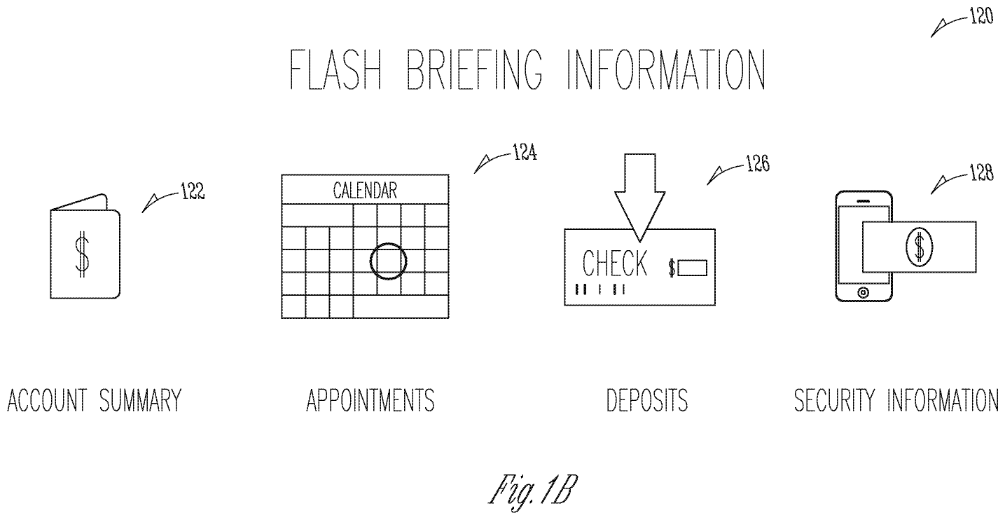

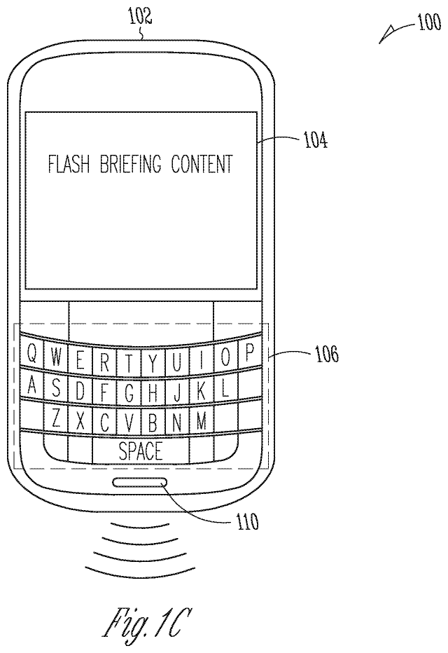

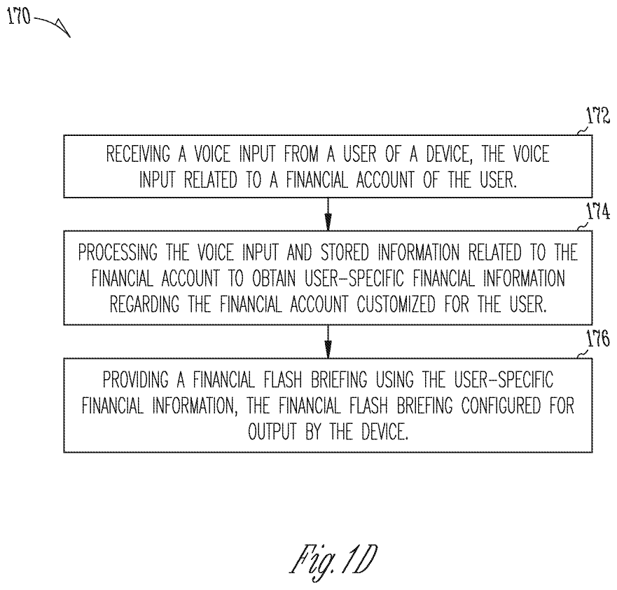

FIG. 1A illustrates an example embodiment of a system for providing a voice enabled flash briefing of banking information. A user 180 provides a voice command that may be directed to a handheld device 100, such as a tablet or smartphone, and/or directed to a smart speaker or smart home controller 150. If directed to a handheld device 100, a voice session may be initiated by tapping a voice button or by saying a wake or trigger word from a specialized keyboard. The system initiates a voice conversation with the user, in various embodiments. A voice command may then be used by the user of the handheld device 100 to request a flash briefing. If directed to a smart speaker or controller 150, a voice command may be directly used to request a flash briefing. Since some smart home controllers 150 and most handheld devices 100 include a visual display, the flash briefing may include both audio and visual components on these devices, in various embodiments. The present subject matter provides a user's account information in a format that is easily consumable on smart speakers and smart home controllers. For example, a short summary of information in digest form may be provided on a voice channel in the flash briefing.

FIG. 1B illustrates example embodiments of information 120 that may be provided for a voice enabled flash briefing of banking information. In some embodiments, account summary information 122 may be provided in the flash briefing. The account summary information 122 may include debit card transactions and/or check draft transactions. The transactions may be categorized by spending category on a daily or weekly basis, in various embodiments. In some embodiments, appointment information 124 may be provided in the flash briefing. The appointment information 124 may include any upcoming appointments and/or upcoming bills on a calendar of a user that will occur in the time frame that the briefing is configured for (e.g., daily, weekly, monthly). In some embodiments, deposit information 126 may be provided in the flash briefing. The deposit information 126 may include content summarizing deposits received or upcoming/expected in the time frame that the briefing is configured for (e.g., daily, weekly, monthly). In some embodiments, security information 128 may be provided in the flash briefing. The security information 128 may include any security-related data that requires the user's attention. For example, security information 128 may include changes in the user's email address, pending validations, potential fraudulent transactions, or payment reminders. All types of information in the flash briefing may be provided as audio information, visual information, or a combination of audio and visual information, depending on the capabilities of the device used, in various embodiments.

FIG. 1C illustrates an example embodiment of a user interface for a voice enabled flash briefing of banking information. The user interface of mobile device 102 includes flash briefing content 104, keyboard 106, and audio input/output 110. In various examples, the user interface is presented on a touch screen of mobile device 102. In various embodiments, the keyboard may be virtual on a touch screen of the mobile device 102. In various embodiments, the keyboard may include a financially context-aware keyboard, including but not limited to the keyboard disclosed in commonly-owned U.S. Provisional Patent Application No. 62/748,704, entitled “PREDICTIVE TEXT SYSTEM”, which is hereby incorporated by reference it its entirety.

In various embodiments, word embedding may be used for flash briefing content. In some embodiments, a proprietary voice engine may be used to initiate the flash briefing. In other embodiments, a vendor's speech-to-text and text-to-speech conversion components may be used to translate a user's queries and to read out the flash briefing content. Various time frames of interest may be used, including daily, weekly, monthly or annually, for example. In some embodiments, a deep learning-based algorithm may be used to classify user transactions into categories using merchant data, such as Yellow Pages merchant data. For example, categories may include clothing, transportation, online shopping, etc. The categorized transactions may then be summarized with a total for each appropriate category. In one example, the top three or four (or programmable number) of categories are read out through a voice channel for the flash briefing, and additional categories may be provided as a visual output to complement the flash briefing.

Data used for the flash briefing, including upcoming appointment information, deposits, and security information, may be obtained by a financial institution from a system of records, in various embodiments. For mobile devices, voice conversation may be enabled through intent recognition (like a chatbot, for example) and matching in Euclidean space between preconfigured intents and user speech, in various embodiments. In one example, a predetermined voice command such as “give my daily briefing” may be used by the user to initiate the flash briefing.

The customer financial information is pre-processed prior to presentation, in various embodiments. For example, spending may be categorized for presentation in the flash briefing. Machine learning algorithms, deep learning-based classification algorithms, and/or recurrent neural networks are used to prepare content specifically designed for individual users, in various embodiments. According to various embodiments, presentation of a financial flash briefing may be device-dependent. In one example, a voice-only flash briefing is provided if a flash briefing is requested via a smart speaker without a visual display, but a voice and visual flash briefing is provided if the flash briefing is requested via a device having a graphical user interface (GUI).

In various embodiments, different default flash briefing formats are used based on the financial and demographic situation of the user. For example, a retirement-age investor will likely want different information in the flash briefing than a college student. In some embodiments where a flash briefing is provided using display output, selectable user interface elements are provided that relate specifically to financial information for flash briefings, such as the user-specific information described in connection with FIG. 1B. The default flash briefing format chosen based on the financial and/or demographic situations of a user may incorporate some of these specific selectable user interface elements. For instance, a default flash briefing format chosen for a DDA user/customer may contain only outgoing and incoming transactions by category together with security information, but without appointment information. Also, further customization may be offered depending on the number of transactions per category. In some embodiments, a default presentation may include the categories with the most number of transactions (e.g. groceries as opposed to eating out). The default settings may be overridden by the customer at any time after enrolling for the briefings, in various embodiments.

FIG. 1D illustrates an example embodiment of a computer-implemented method 170 for providing a voice enabled flash briefing of banking information. The method 170 includes receiving, by a processor of a computer, a voice input from a user of a device, the voice input related to one or more financial accounts of the user, at operation 172. At operation 174, the processor processes the voice input and stored information related to the one or more financial accounts to obtain user-specific financial information regarding the one or more financial accounts and, optionally, to customize the obtained information for presentation to the user. The processor provides a financial flash briefing using the user-specific financial information at operation 176, the financial flash briefing configured for output by the device.

In various embodiments, processing the voice input and stored information related to the financial account includes using a machine learning system. Providing a financial flash briefing using the user-specific financial information includes providing a device-dependent output, in some embodiments. The device-dependent output may include an audio output if the device is configured with a speaker for audio outputs, and may include both an audio output and a display output if the device is configured with a speaker for audio outputs and a graphical user interface (GUI) for display outputs, in various embodiments. In one embodiment, a server stores device type and output options for each device type in a database. The output options are configurable by a user, in an embodiment. In various embodiments, the output may be sent in a variety of formats to the device, and the device may process the formats to determine which are compatible for output at the device. While default flash briefing formats may be utilized in this way, a user may also predefine which flash briefing formats the user prefers to receive from particular devices or, more generally, from devices having specific device configurations (e.g., where the device can produce audio output but not a display, can produce a display but not audio output, or can produce both audio output and a display).

In addition, the format of the flash briefing may be customized based on a financial situation of the user, such as based on an account balance or types of account (e.g. DDA+Auto Loan or DDA+Trust Account), in various embodiments. For instance, if the customer's credit standing improved then a change in Auto Loan interest rate may be presented. Additionally, or alternatively, the format of a given flash briefing may be manually curated by the user via a user interface presented by a financial institution app 411.

Various embodiments of the present subject matter include a system for providing a voice enabled flash briefing of banking information. The system includes a computing device comprising at least one processor and a data storage device in communication with the at least one processor. The data storage device includes instructions thereon that, when executed by the at least one processor, causes the at least one processor to receive a voice input from a user of a device, the voice input related to a financial account of the user. The voice input and stored information related to the financial account are processed to obtain user-specific financial information regarding the financial account customized for the user. In one embodiment, the information is stored in a database at the financial institution. In another embodiment, the information is stored in a cloud database that is accessed by the computing device and/or the device. A financial flash briefing is provided using the user-specific financial information, the financial flash briefing configured for output by the device. In various embodiments, the financial flash briefing includes information related to an account summary of the financial account, information related to appointments and/or upcoming bills of the user, information related to deposits in the financial account, and/or information related to security information relevant to the financial account.

In various embodiments, a non-transitory computer-readable storage medium is provided. The computer-readable storage medium includes instructions that when executed by computers, cause the computers to perform operations of receiving a voice input from a user of a device, the voice input related to a financial account of the user, processing the voice input and stored information related to the financial account to obtain user-specific financial information regarding the financial account customized for the user, and providing a financial flash briefing using the user-specific financial information, the financial flash briefing configured for output by the device. According to various embodiments, the device may include a smartphone, a tablet, a smart speaker, and/or a smart home controller with a GUI.

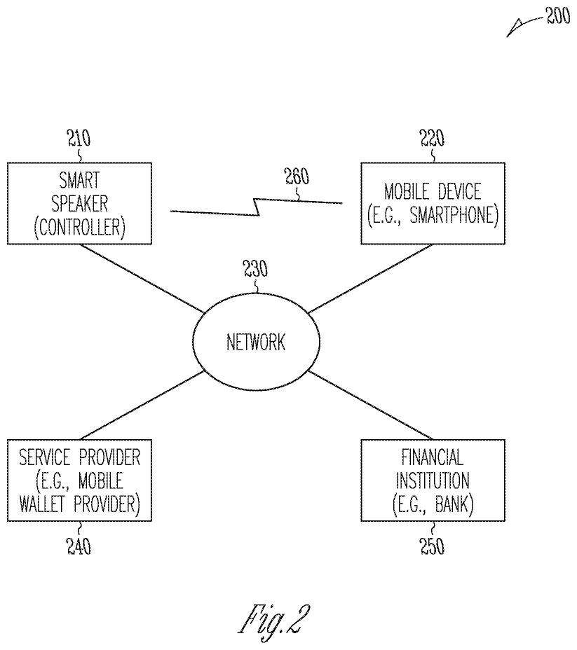

FIG. 2 illustrates an exemplary infrastructure for providing a voice enabled flash briefing of banking information. The infrastructure may comprise a smart speaker (or smart controller) 210, a mobile device (e.g., smartphone or wearable device) 220, a service provider 240, and a financial institution 250, a network 230, and a device network 260. The mobile device 220 may be a mobile computing device such as smartphone, tablet computer, or other portable computing device. Exemplary mobile devices include the Apple iPhone and Samsung Galaxy smartphone. Exemplary smart speakers or controllers include Amazon Echo, Amazon Echo Spot, Amazon Echo Dot, Amazon Echo Show, Amazon Echo Auto, Apple Home Pod, Google Home, and Google Home Hub. Exemplary service providers include Amazon, Google, Apple, and Samsung. The financial institution 250 may be an organization that provides an account for the primary account holder, in various embodiments. Exemplary financial institutions include bank, credit/debit card companies, and the like.

The network 230 represents a virtual network that provides communication between entities 210, 220, 240 and 250. The network 230 may comprise Internet, LAN, Wi-Fi, home network, cellular network, NFC, and other types of networks, in various embodiments. The device network 260 may be a wireless communication network between the mobile device 220 and smart speaker 210 only. Exemplary wireless networks 260 are a Local area network (LAN), Personal Area Network (PAN), and body area network (BAN). The wireless network 260 may use Bluetooth, Near Field Communication (NFC), Wi-Fi, ZigBee, or other wireless technology, in various embodiments.

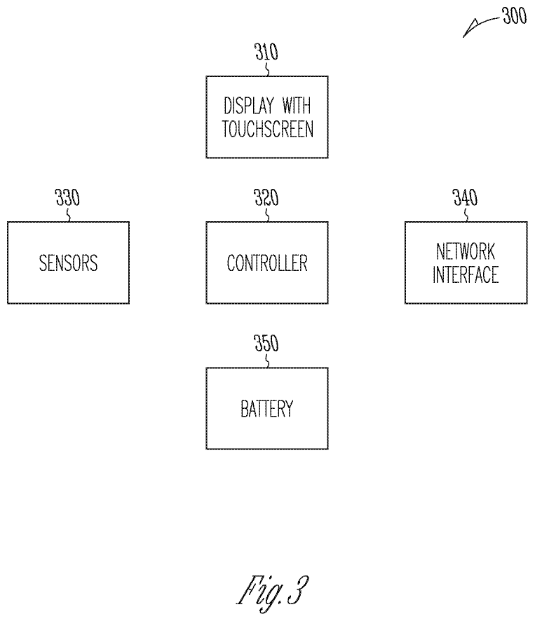

FIG. 3 illustrates an embodiment of computing device 300 used by a user to display a voice enabled flash briefing of banking information. In the depicted embodiment, the computing device 300 includes a display with a touchscreen 310 interfaced with a controller or processor 320. The controller or processor 320 is electrically connected to one or more sensors 330, a network interface 340, and a battery 350 to supply power to the computing device 300, in various embodiments. FIG. 3 is merely a non-limiting example of a computing device and many other devices may be used to facilitate the functionality described herein.

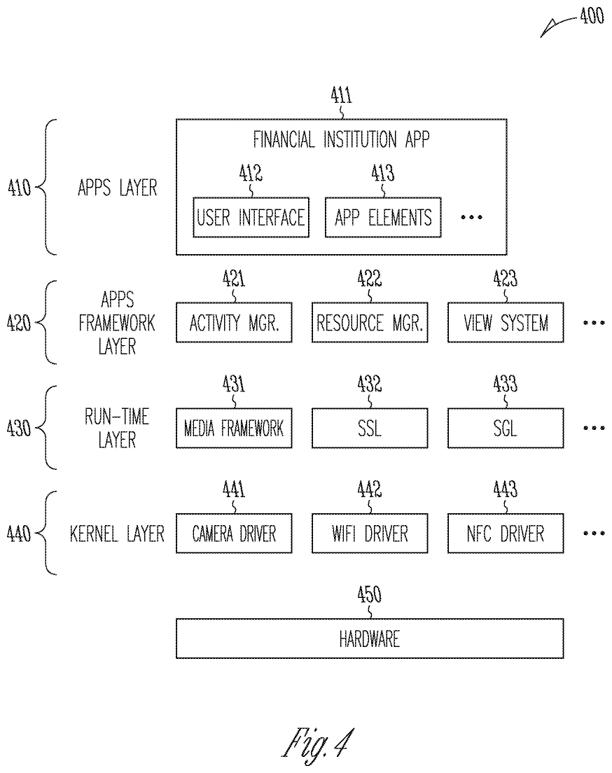

FIG. 4 illustrates an embodiment of a computing device 400 with a financial institution application 411. In various embodiments, the computing device 400 includes a mobile computing device such as a cellular telephone or smart phone. The depicted embodiment illustrates one example of software architecture executed on hardware 450, including one or more processors of the computing device 400. FIG. 4 is merely a non-limiting example of a software architecture and many other architectures may be implemented to facilitate the functionality described herein.

The representative hardware 450 comprises one or more processing units having associated executable instructions. Executable instructions represent the executable instructions of the software architecture, including implementation of the methods, modules, and components of the present subject matter. Hardware 450 also includes memory and/or storage modules, which also have executable instructions.

In the example architecture of FIG. 4, the software may be conceptualized as a stack of layers where each layer provides particular functionality. For example, the software may include layers such as an operating system, libraries, frameworks/middleware, applications and presentation layer. Other software architectures may include additional or different layers. The operating system may manage hardware resources and provide common services. The overall system may include, for example, a kernel layer 440, run-time layer 430, application framework layer 420 and application layer 410. The kernel layer 440 may act as an abstraction layer between the hardware and the other software layers. For example, the kernel layer 440 may be responsible for memory management, processor management (e.g., scheduling), component management, networking, security settings, and so on. The drivers may be responsible for controlling or interfacing with the underlying hardware. For instance, the drivers may include display drivers, camera drivers 441, Bluetooth® drivers, flash memory drivers, serial communication drivers (e.g., Universal Serial Bus (USB) drivers), Wi-Fi® drivers 442, near field communication (NFC) drivers 443, audio drivers, power management drivers, and so forth depending on the hardware configuration.

The run-time layer 430 may include a media framework 431, a secure sockets layer (SSL) 432 and a secure group layer (SGL) 433, in various embodiments. The application framework layer 420 may include an activity manager 421, a resource manager 422, and a view system application 423, in various embodiments. The application layer 410 may include built-in applications and/or third-party applications. Examples of representative built-in applications may include, but are not limited to, a contacts application, a browser application, a book reader application, a location application, a media application, a messaging application, and/or a game application. Third-party applications may include any of the built-in applications as well as a broad assortment of other applications. In a specific example, the third-party application (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application may invoke application programming interface (API) calls provided by the operating system to facilitate functionality described herein. A financial institution application 411 may implement the functionality of a voice enabled flash briefing of banking information, in one embodiment. The voice enabled flash briefing of banking information may be provided by a built-in or third-party application, which may include a user interface 412 and application elements 413 in various embodiments.

The applications in application layer 410 may utilize built in operating system functions (e.g., kernel, services and/or drivers), libraries, frameworks and middleware to create user interfaces to interact with users of the system. Alternatively, or additionally, in some systems interactions with a user may occur through a presentation layer. In these systems, the application/module “logic” may be separated from the aspects of the application/module that interact with a user.

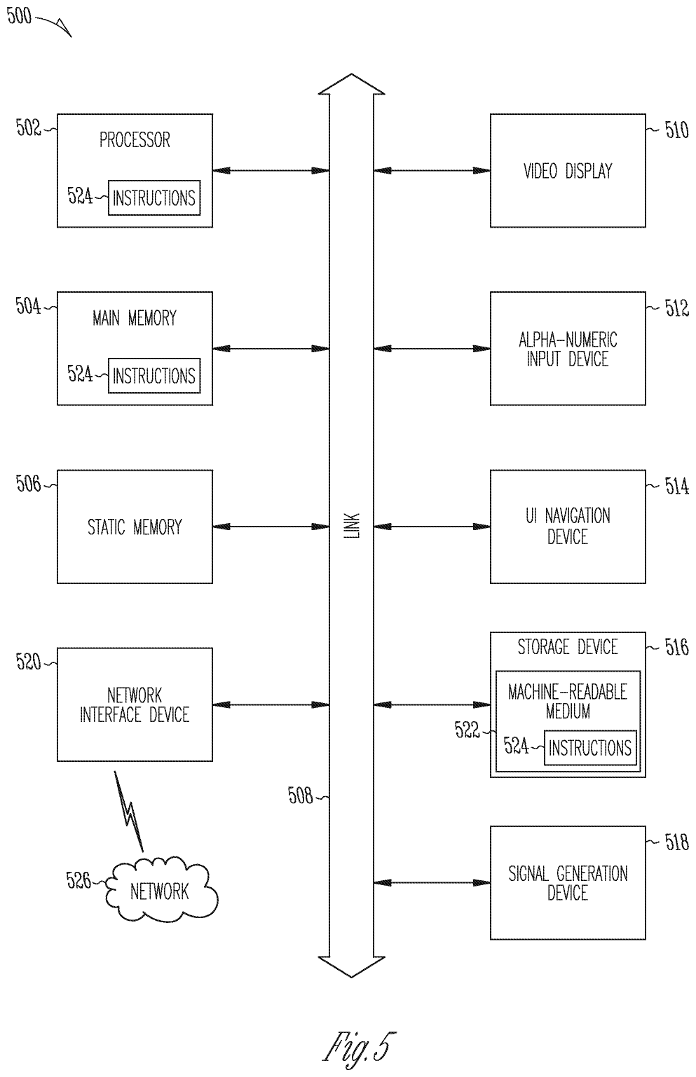

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a personal computer (PC), a tablet PC, a hybrid tablet, a set-top box (STB), a personal digital assistant (PDA), a mobile or cellular telephone such as a smart phone, a wearable device such as a smart watch, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The data storage device 516 includes a machine-readable medium 522 on which is stored one or more sets of data structures and instructions 524 (e.g., software) embodying or utilized by any one or more of the methodologies or functions described herein. The instructions 524 may include a machine learning system or algorithm, and may also reside, completely or at least partially, within the main memory 504, static memory 506, and/or within the processor 502 during execution thereof by the computer system 500, with the main memory 504, static memory 506, and the processor 502 also constituting machine-readable media.

While the non-transitory computer-readable storage medium 522 is illustrated in an example embodiment to be a single medium, the term “machine-readable medium” or “computer-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions (e.g., instructions 524) for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone system (POTS) networks, and wireless data networks (e.g., Wi-Fi, 3G, and 6G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A computer-implemented method comprising:
receiving, by a processor of a computer, a voice input from a user of a device, the voice input related to a financial account of the user;
processing, by the processor, the voice input using intent recognition and matching between preconfigured intents and user speech using stored information related to the financial account to obtain user-specific financial information regarding the financial account customized for the user;
presenting, by the processor, a user interface on the device, the user interface including a financially-context aware keyboard including a character input portion and a predictive suggestion portion;
converting, by the processor, a set of characters entered by a user in the character input portion into a word vector:
inputting, by the processor, the word vector into a neural network;
determining, by the processor, a set of output terms from the neural network;
retrieving, by the processor, a set of account types for the user from a user profile;
querying, by the processor, a data store to retrieve a user specific numerical data value, from an account type corresponding to one of the set of account types, for an output term of the set of output terms;
presenting, by the processor, a paired output term that includes the output term and the user specific numerical data value in the predictive suggestion portion of the user interface, the paired output term presented as a user interface element:
receiving, by the processor, an input via the user interface, the input including a selection of the user interface element and providing a preferred format of a financial flash briefing for each of a plurality of user devices and a first number of categories for voice briefings;
accessing, by the processor, external storage to obtain a plurality of user transactions and related merchant data;
determining, by the processor, audio and video capability of the device of the user;
classifying, by the processor, the plurality of stored user transactions into categories using the merchant data and using a deep learning-based algorithm; and
automatically providing, by the processor, the financial flash briefing as an output of the device using a customized format based on a default format, the determined capability of the device, the user-specific financial information and the preferred format, the financial flash briefing including the first number of categories of voice briefings and a second number categories of visual briefings, wherein the second number is greater than the first number, the financial flash briefing including the user-specific financial information and the classified plurality of stored user transactions, wherein automatically providing the financial flash briefing includes using a machine learning algorithm to prepare content specifically for the user including:
providing information related to an account summary of the financial account, including providing a list of transactions by spending category over a preconfigured time period;
providing information related to appointments and upcoming bills of the user, including providing a list of appointments and bills of the user derived from an electronic calendar of the user over the preconfigured time period;
providing information related to deposits in the financial account, including providing a summary of deposits received and expected over the preconfigured time period; and
providing information related to security information relevant to the financial account, including providing a summary of changes in an email address of the user, potential fraudulent transactions, and payment reminders over the preconfigured time period.

2. The method of claim 1, wherein processing the voice input and stored information related to the financial account includes using a machine learning system.

3. The method of claim 1, wherein providing the financial flash briefing using the user-specific financial information includes providing a device-dependent output.

4. The method of claim 3, wherein the device-dependent output includes an audio output if the device is configured with a speaker for audio outputs.

5. The method of claim 3, wherein the device-dependent output includes an audio output and a display output if the device is configured with a speaker for audio outputs and a graphical user interface (GUI) for display outputs.

6. The method of claim 1, wherein providing the financial flash briefing using the user-specific financial information includes customizing the financial flash briefing based on interface elements selected by the user.

7. The method of claim 1, wherein providing the financial flash briefing using the user-specific financial information includes customizing the financial flash briefing based on a number of transactions per category by the user.

8. The method of claim 1, wherein providing the financial flash briefing using the user-specific financial information includes customizing the financial flash briefing based on an age of the user.

9. The method of claim 1, wherein providing the financial flash briefing using the user-specific financial information includes customizing the financial flash briefing based on a balance of the financial account.

10. The method of claim 1, wherein providing the financial flash briefing using the user-specific financial information includes customizing the financial flash briefing based on an account type of the financial account.

11. A system comprising:
a computing device comprising at least one processor and a data storage device in communication with the at least one processor, wherein the data storage device comprises instructions thereon that, when executed by the at least one processor, causes the at east one processor to:
receive a voice input from a user of a device, the voice input related to a financial account of the user;
process the voice input using intent recognition and matching between preconfigured intents and user speech using stored information related to the financial account to obtain user-specific financial information regarding the financial account customized for the user;
present a user interface on the device, the user interface including a financially-context aware keyboard including a character input portion and a predictive suggestion portion:
convert a set of characters entered by a user in the character input portion into a word vector;
input the word vector into a neural network;
determine a set of output terms from the neural network;
retrieve a set of account types for the user from a user profile;
query a data store to retrieve a user specific numerical data value, from an account type corresponding to one of the set of account types, for an output term of the set of output terms;
present a paired output term that includes the output term and the user specific numerical data value in the predictive suggestion portion of the user interface, the paired output term presented as a user interface element:
receive an input via the user interface, the input including a selection of the user interface element and providing a preferred format of a financial flash briefing for each of a plurality of user devices and a first number of categories for voice briefings;
access external storage to obtain a plurality of user transactions and related merchant data;
determine audio and video capability of the device of the user;
classify the plurality of stored user transactions into categories using the merchant data and using a deep learning-based algorithm; and
automatically provide the financial flash briefing as an output of the device using a customized format based on a default format, the determined capability of the device, the user-specific financial information and the preferred format, the financial flash briefing including the first number of categories of voice briefings and a second number categories of visual briefings, wherein the second number is greater than the first number, the financial flash briefing including the user-specific financial information and the classified plurality of stored user transactions; wherein automatically providing the financial flash briefing includes using a machine learning algorithm to prepare content specifically for the user including:
providing information related to an account summary of the financial account, including providing a list of transactions by spending category over a preconfigured time period;
providing information related to appointments and upcoming bills of the user, including providing a list of appointments and bills of the user derived from an electronic calendar of the user over the preconfigured time period;
providing information related to deposits in the financial account, including providing a summary of deposits received and expected over the preconfigured time period; and
providing information related to security information relevant to the financial account, including providing a summary of changes in an email address of the user, potential fraudulent transactions, and payment reminders over the preconfigured time period.

12. The system of claim 11, wherein the financial flash briefing includes information related to an account summary of the financial account.

13. The system of claim 11, wherein the financial flash briefing includes information related to appointments and upcoming bills of the user.

14. The system of claim 11, wherein the financial flash briefing includes information related to deposits in the financial account.

15. The system of claim 11, wherein the financial flash briefing includes information related to security information relevant to the financial account.

16. A non-transitory computer-readable storage medium, the computer-readable storage medium including instructions that when executed by computers, cause the computers to perform operations of:
receiving a voice input from a user of a device, the voice input related to a financial account of the user;
processing the voice input using intent recognition and matching between preconfigured intents and user speech using stored information related to the financial account to obtain user-specific financial information regarding the financial account customized for the user;
presenting a user interface on the device, the user interface including a financially-context aware keyboard including a character input portion and a predictive suggestion portion:
converting a set of characters entered by a user in the character input portion into a word vector:
inputting the word vector into a neural network;
determining a set of output terms from the neural network;
retrieving a set of account types for the user from a user profile;
querying a data store to retrieve a user specific numerical data value, from an account type corresponding to one of the set of account types, for an output term of the set of output terms;
presenting a paired output term that includes the output term and the user specific numerical data value in the predictive suggestion portion of the user interface, the paired output term presented as a user interface element:
receiving an input via the user interface, the input including a selection of the user interface element and providing a preferred format of a financial flash briefing for each of a plurality of user devices and a first number of categories for voice briefings;
accessing external storage to obtain a plurality of user transactions and related merchant data;
determining audio and video capability of the device of the user;
classifying the plurality of stored user transactions into categories using the merchant data and using a deep learning-based algorithm; and
automatically providing the financial flash briefing as an output of the device using a customized format based on a default format, the determined capability of the device, the user-specific financial information and the preferred format, the financial flash briefing including the first number of categories of voice briefings and a second number categories of visual briefings, wherein the second number is greater than the first number, the financial flash briefing including the user-specific financial information and the classified plurality of stored user transactions, wherein automatically providing the financial flash briefing includes using a machine learning algorithm to prepare content specifically for the user including:
providing information related to an account summary of the financial account, including providing a list of transactions by spending category over a preconfigured time period;
providing information related to appointments and upcoming bills of the user, including providing a list of appointments and bills of the user derived from an electronic calendar of the user over the preconfigured time period;
providing information related to deposits in the financial account, including providing a summary of deposits received and expected over the preconfigured time period; and
providing information related to security information relevant to the financial account, including providing a summary of changes in an email address of the user, potential fraudulent transactions, and payment reminders over the preconfigured time period.

17. The non-transitory computer-readable storage medium of claim 16, wherein the device includes a smartphone.

18. The non-transitory computer-readable storage r tedium of claim 6, wherein the device includes a tablet.

19. The non-transitory computer-readable storage medium of claim 16, wherein the device includes a smart speaker.

20. The non-transitory computer-readable storage medium of claim 16, wherein the device includes a smart home controller with a GUI.
